(19) United States
(12) Patent Application Publication
(10) Pub. No.: US 2026/0110318 A1
(43) Pub. Date: Apr. 23, 2026

(54) ENHANCED VISIBILITY FASTENER

(71) Applicant: Deluge Enterprises, LLC, Labadie, MO (US)

(72) Inventor: James Michael Rains, Labadie, MO (US)

(21) Appl. No.: 18/919,038

(22) Filed: Oct. 17, 2024

(51) Int. Cl. F16B 15/02

(52) U.S. Cl. CPC F16B 15/02

(57) ABSTRACT

A fastener has enhanced visibility by a fluorescent material coating applied to recessed surfaces formed in a strike surface of the head of the fastener. The fluorescent material coating on the recessed surface is protected by the raised strike surface of the fastener from being impacted by a tool and worn or chipped from the fastener. The fluorescent material of the coating will fluoresce when exposed to ultraviolet radiation light thereby enhancing the visibility of the fastener.

### BACKGROUND OF THE INVENTION

At construction sites where nails are used as fasteners, for example roofing nails used in installing shingles on a roof, it is a common problem that nails will be dropped or fall from the construction site and be lost in the surroundings. The cleanup process after the installation of a new shingle roof requires a substantial amount of time spent in locating nails that have fallen from the roof during the installation. The time spent by a roofing crew in looking for lost nails is time taken away from roofing installation work and is not profitable time.

An enhanced visibility fastener is needed to facilitate locating lost nails and making the construction site cleanup process more time efficient.

### SUMMARY OF THE INVENTION

The enhanced visibility fastener of this disclosure is configured as a nail, for example a roofing nail. The nail has structural components that are common to most nails and includes novel and unique structural features that enhance the visibility of the nail. Although the fastener is described herein as a nail, the unique structural features that enhance the visibility of the nail can be employed on other fasteners such as screws.

The nail of this disclosure comprises common nail structural features such as a shank, a point and a head. The shank has a length that extends between the point at the first end of the shank and the head at the opposite, second end of the shank.

The unique structural features of the nail are provided at the strike surface on the head of the nail, or the side of the head that is opposite the shank.

A recess, or preferably a plurality of recesses, are formed in the strike surface. Each recess extends into the head from the strike surface to a recessed surface of the recess inside the head. The plurality of recesses on the strike surface can form a grid, waffle, or dimple pattern on the strike surface around the plurality of recesses.

A coating layer is adhered to the strike surface. The coating layer extends into each recess and coats each recessed surface. The coating is highly visible, often a fluorescent material that is adhered to the recessed surface. To achieve good adherence of the fluorescent material to the recessed surface, the fluorescent material has been powder coated on the recessed surface. The fluorescent material is a powder that has been sprayed onto the strike surface and injected into each recess and coats the recessed surface. The powder is adhered to the recessed surface by being heat cured on the recessed surface, thereby producing the coating adhered to the recessed surface. The fluorescent material adhered to the recessed surface is more durable and more resistant to strike impact forces and chemical reactions than a paint coating.

### BRIEF DESCRIPTION OF DRAWINGS

Further objects and features of the enhanced visibility fastener of this disclosure are set forth in the following detailed description and in the drawing figures.

FIG. 1 is a representation of a side elevation view of the enhanced visibility fastener of this disclosure.

FIG. 2 is a schematic representation of a perspective view of the strike surface of the fastener.

FIG. 3 is a representation of a perspective view of a variation of the strike surface of the fastener.

FIG. 4 is a representation of a perspective view of a further variation of the strike surface of the fastener.

FIG. 5 is a schematic representation of an enlarged view of a portion of the strike surface shown circled in FIG. 4.

### DETAILED DESCRIPTION OF THE INVENTION

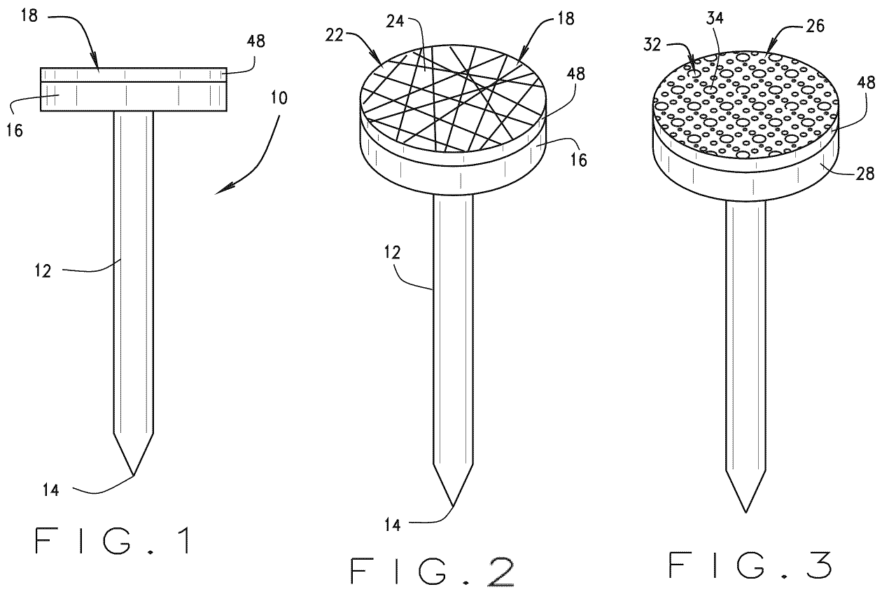

FIG. 1 is a representation of a side elevation view of the enhanced visibility fastener 10 of this disclosure. In the embodiment represented in FIG. 1, the enhanced visibility fastener is configured as a nail 10, for example a roofing nail. The nail 10 has structural components that are common to most nails and includes novel and unique structural features that enhance the visibility of the nail. Although the fastener is described herein as a roofing nail 10, the unique structural features that enhance visibility of the nail can be employed on nails of all types and on other fasteners, such as bolts and nuts, screws, etc.

The nail 10 of this disclosure comprises typical nail structural features such as a shank 12, a point 14 and a head 16. The shank 12 has a cylindrical exterior surface with a straight length that extends between the point 14 at a first end of the shank and the head 16 at an opposite, second end of the shank. The nail 10 is constructed from commonly used materials such as metals but could be constructed of other equivalent types of materials that provide the nail with sufficient structural strength for its intended use. The nail 10 is constructed by any known method of nail construction and their equivalents. The nail 10 in the example represented in FIG. 1 is a roofing nail configured for use in a conventional nail gun.

The head 16 of the nail 10 has the typical circular or disk-like configuration with a strike surface 18 on a side of the head opposite the shank 12. The unique structural features of the nail 10 are provided at the strike surface 18 of the nail. The strike surface 18 is the exterior surface on the head 16 that is constructed for being impacted by a striking tool, for example by the head of a hammer or a nail gun.

As schematically represented in FIG. 2, the strike surface 18 is constructed as a textured surface. The schematic representation of the strike surface 18 provided in FIG. 2 is to represent that the texture of the strike surface 18 can have a variety of configurations. Each configuration provides the strike surface 18, for example a strike surface defined by a plurality of raised ridges crisscrossing the head with one or more recesses 22 into the strike surface 18 below the plurality of raised ridges with each recess extending into the head of the nail from the strike surface 18. Each recess 22 extends into the head 16 from the strike surface 18 to a recessed surface 24. Each recessed surface 24 is positioned in the head 16 below the raised strike surface 18 of the head 16 and at the bottom of a recess 22.

FIG. 3 represents the strike surface 26 of the nail head 28 having a textured surface with a configuration formed by recesses 32 defined by semicircular shaped surfaces 34 that are recessed into the strike surface 26 of the head 28. The plurality of recesses 32 give the strike surface 26 a dimpled configuration with the recessed surfaces 34 at the bottoms of the semicircular surfaces 32 in the strike surface 26. The strike surface 26 is formed by circular raised edges around the tops of the recesses 32.

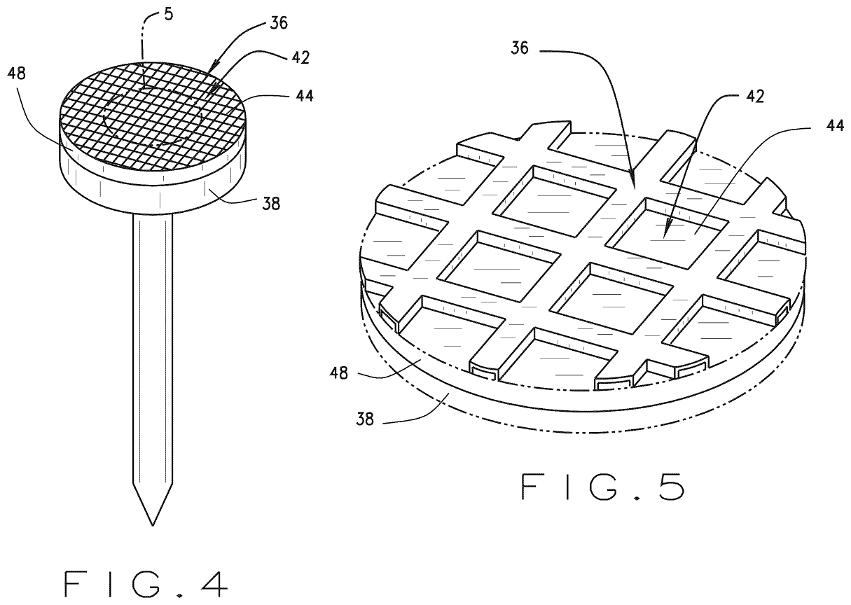

FIG. 4 represents the strike surface 36 of the nail head 38 having a textured surface with a configuration formed by rectangular recesses 42 defined by rectangular recessed surfaces 44 that are recessed into the strike surface 36 of the head 38. The plurality of recesses 42 give the strike surface 36 a rectangular grid pattern around with the plurality of recesses 42. The strike surface 36 is formed of rectangular raised edges around the tops of the recesses 42. The plurality of recesses 42 extend from the grid pattern of the strike surface 36 into the head 38 to recessed surfaces 44 in each of the recesses.

FIG. 5 is a representation of the portion of the strike surface 36 shown circled in FIG. 4. FIG. 5 provides an enlarged view of the portion of the strike surface 36 to better represent the details of the strike surface to be described. As represented in FIG. 5, the plurality of recesses 42 extend into the head 38 of the nail to the recessed surfaces 46 at the bottoms of the recesses. Each recess 42 extends into the head 38 from the strike surface 36 to a recessed surface 44 inside the head. As represented in FIGS. 4 and 5, the plurality of recesses 42 form a grid pattern of the strike surface 36 around the plurality of recessed surfaces 44.

In each of the examples of the strike surface 18, 26, 36 described above, there is a layer of a coating 48 applied over the strike surface. The coating 48 is adhered to each strike surface. The coating 48 extends into each of the recesses 22, 32, 42 and coats each recessed surface 24, 34, 44. The coating 48 is a fluorescent material that is adhered to the recessed surface. The fluorescent material of the coating 48 is highly visible under standard illuminating circumstances, such as sunlight or visible light, and emits light or will fluoresce when exposed to ultraviolet radiation light. The fluorescence occurs when a photon of the incoming ultraviolet radiation light is absorbed by an orbital electron in a molecule of the coating material 48, exciting the electron to a higher level. The electron then returns to its ground state, emitting a photon of a different frequency than the impinging or incoming photon, which causes the fluorescent glow.

To achieve good adherence of the fluorescent material 48 to the recessed surface 24, 34, 44, the fluorescent material coating 48 has been powder coated on the recessed surface. The fluorescent material coating 48 is a powder that has been sprayed onto each of the strike surfaces 18, 26, 36 and injected into the recesses 22, 32, 42 and coats the recessed surfaces 24, 34, 44. The powder of the coating 48 has been adhered to the recessed surfaces by being heat cured on the recessed surfaces. The fluorescent material of the coating 48 adhered to the recessed surfaces 24, 34, 44 is chemically bonded to the recessed surfaces as a result of the curing by heating of the coating.

Curing the powder of the coating 48 often results in a smooth uniform film. Chemical processes during curing, such as polymerization and crosslinking, cause the fluorescent material of the coating 48 adhered to the recessed surfaces 24, 34, 44 to be more durable and more resistant to strike impact forces and chemical reactions than a paint coating. Thus, the fluorescent material of the coating 48 may wear away from the strike surfaces 18, 26, 36 of the nail heads as the nails are used, but will remain on the recessed surfaces 24, 34, 44. The fluorescent material of the coating 48 on the recessed surfaces 24, 34, 44 fluoresces when exposed to ultraviolet light. The fluorescence of the fluorescent material coating 46 on the recessed surfaces 24, 34, 44 enhances the visibility of the nails of this disclosure and facilitates locating nails lost in the surroundings of a construction site.

The fluorescence of the fluorescent material coating 48 on the recessed surfaces 24, 34, 44 enhances the visibility of the nails and facilitates detecting nails securing shingles on a roof that have been improperly located in the shingles and are exposed and not covered by a subsequently nailed shingle on the roof. This enables detecting whether nails are properly positioned when used to secure shingles on a roof, with properly positioned nails being covered by subsequently secured shingles. Only improperly positioned nails that are not covered by a subsequently secured shingle would be exposed to ultraviolet light and thus fluoresce. The fluorescence of the nails detects the improperly secured nails.

As various modifications could be made in the construction of the enhanced visibility fastener and its method of use herein described and illustrated without departing from the scope of the invention, it is intended that all matter contained in the foregoing description or shown in the accompanying drawings shall be interpreted as illustrative rather than limiting. Thus, the breadth and scope of the present disclosure should not be limited by any of the above described exemplary embodiments but should be defined only in accordance with the following claims appended hereto and their equivalents.

1. A nail comprising:
a shank having a length with opposite first and second ends;
a point on the first end of the shank;
a head on the second end of the shank;
a strike surface on the head;
a recess on the strike surface, the recess extending into the head from the strike surface to a recessed surface inside the recess and inside the head; and
a coating adhered to the recessed surface.

2. The nail of claim 1, further comprising:
the coating adhered to the recessed surface is a fluorescent material adhered to the recessed surface.

3. The nail of claim 2, further comprising:
the fluorescent material adhered to the recessed surface has been powder coated on the recessed surface.

4. The nail of claim 2, further comprising:
the fluorescent material adhered to the recessed surface is more durable and resistant to strike impact forces and chemical reactions than a paint coating.

5. The nail of claim 2, further comprising:
the fluorescent material adhered to the recessed surface is chemically bonded to the recessed surface as a result of curing by heating the coating adhered to the recessed surface.

6. The nail of claim 2, further comprising:
the fluorescent material adhered to the recessed surface is chemically excited by exposure to ultraviolet light.

7. The nail of claim 1, further comprising:
the nail is configured for use in a nail gun.

8. The nail of claim 1, further comprising:
the recess on the strike surface is one recess of a plurality of recesses on the strike surface.

9. The nail of claim 8, further comprising:
the plurality of recesses on the strike surface form a grid pattern on the strike surface around the plurality of recesses.

10. The nail of claim 1, further comprising:
the recess on the strike surface contains ionized powder that has been injected into the recess and adhered to the recessed surface forming the coating adhered to the recessed surface.

11. The nail of claim 10, further comprising:
the ionized powder has been adhered to the recessed surface by being heat cured on the recessed surface.

12. A nail comprising:
a shank having a length with opposite first and second ends;
a point on the first end of the shank;
a head on the second end of the shank;
a raised surface on the head, the raised surface being configured for being struck by a striking tool;
a recessed surface on the head, the recessed surface being positioned relative to the head below the raised surface;
a coating layer on the recessed surface, the raised surface being positioned relative to the head above the coating layer on the recessed surface and shielding the coating layer on the recessed surface from being struck by a striking tool striking the head.

13. The nail of claim 12, further comprising:
the coating layer on the recessed surface is a fluorescent material coating the recessed surface.

14. The nail of claim 13, further comprising:
the fluorescent material coating the recessed surface has been powder coated on the recessed surface.

15. The nail of claim 13, further comprising:
the fluorescent material coating the recessed surface is chemically bonded to the recessed surface from curing by heating the coating layer on the recessed surface.

16. The nail of claim 13, further comprising:
the recessed surface on the head is one recessed surface of a plurality of recessed surfaces on the head.

17. The nail of claim 16, further comprising:
the plurality of recessed surfaces on the head form a grid pattern on the head around the plurality of recessed surfaces.

18. A method of enhancing visibility of a nail comprising:
adhering a coating on a recessed surface in a strike surface on the head of the nail; and
the coating adhered to the recessed surface is a fluorescent material adhered to the recessed surface.

19. The method of claim 18, further comprising:
adhering the fluorescent material on the recessed surface by powder coating the fluorescent material on the recessed surface.

20. The method of claim 19, further comprising:
adhering the fluorescent material on the recessed surface by chemically bonding the fluorescent material to the recessed surface by curing by heating the fluorescent material on the recessed surface.
